(19) United States
(12) Patent Application Publication
(10) Pub. No.: US 2022/0198856 A1
(43) Pub. Date: Jun. 23, 2022

(54) COMMUNICATION CONTROL SYSTEM AND COMMUNICATION CONTROL METHOD

(71) Applicant: KABUSHIKI KAISHA TOKAI RIKA DENKI SEISAKUSHO, Aichi (JP)

(72) Inventors: Keita SOBUE, Aichi (JP); Hiroaki KOJIMA, Aichi (JP); Masayuki KAWAMURA, Aichi (JP)

(73) Assignee: KABUSHIKI KAISHA TOKAI RIKA DENKI SEISAKUSHO, Aichi (JP)

(21) Appl. No.: 17/603,458

(22) PCT Filed: Apr. 7, 2020
(86) PCT No.: PCT/JP2020/015658

§ 371 Date: Oct. 13, 2021

(30) Foreign Application Priority Data
Apr. 18, 2019 (JP) 2019-079337

(51) Int. Cl. G07C 9/00; B60R 25/20; H04W 12/06

(52) U.S. Cl. CPC G07C 9/00817; G07C 2009/00825; H04W 12/06; B60R 25/20

(57) ABSTRACT

A communication control system includes an acquisition unit that obtains setting information when the setting information is input by a user. The setting information is related to a restriction on actuation of an operation subject that is actuated or allowed to be actuated through authentication communication performed with a terminal. The communication control system further includes a restriction unit that restricts actuation of the operation subject when a condition in the setting information is satisfied.

### TECHNICAL FIELD

The invention relates to a communication control system and a communication control method that control communication between a terminal and an operation subject.

### BACKGROUND ART

A known smart verification system performs ID verification through wireless communication between a vehicle and a terminal to actuate an onboard device (refer to Patent Document 1). During smart verification, for example, the vehicle periodically transmits radio waves, the terminal receives the radio waves, and the terminal activated by the radio waves returns ID information to the vehicle. Then, the vehicle verifies the ID information. If ID verification is accomplished, the onboard device is actuated or allowed to be actuated.

### PRIOR ART DOCUMENTS

### Patent Documents

Patent Document 1: Japanese Laid-Open Patent Publication No. 2005-262915

### SUMMARY OF THE INVENTION

### Problems that the Invention is to Solve

Fraudulent acts may be performed by using a relay or the like to relay the radio waves transmitted from a vehicle to a location remote from the vehicle. Such a fraudulent act may accomplish a smart verification unintended by the user. To obviate damage, such as automobile theft, measures need to be taken against such fraudulent acts.

It is an objective of the invention to provide a communication control system and a communication control method that improve the security against unauthorized use of an operation subject.

### Means for Solving the Problems

A communication control system according to one embodiment includes an acquisition unit that obtains setting information when the setting information is input by a user, in which the setting information is related to a restriction on the actuation of an operation subject that is actuated or allowed to be actuated through authentication communication performed with a terminal; and a restriction unit that restricts the actuation of the operation subject when a condition in the setting information is satisfied.

A communication control method according to one embodiment includes obtaining setting information with an acquisition unit when the setting information is input by a user, where the setting information is related to a restriction on the actuation of an operation subject that is actuated or allowed to be actuated through authentication communication performed with a terminal; and restricting the actuation of the operation subject with a restriction unit when a condition in the setting information is satisfied.

### BRIEF DESCRIPTION OF THE DRAWINGS

FIG. 1 is a diagram of a communication control system according to one embodiment.

FIG. 2 is a setting screen for inputting setting information.

FIG. 3 is a schematic diagram illustrating communication established between a terminal and a radio wave transmitter.

FIG. 4 is a diagram illustrating a specific example of a restricted state.

FIG. 5 is a diagram illustrating an example of unauthorized communication using a relay.

FIG. 6 is a schematic diagram illustrating a remote operation performed with a terminal.

FIG. 7 is a cancellation screen for inputting a passcode to cancel restriction.

### MODES FOR CARRYING OUT THE INVENTION

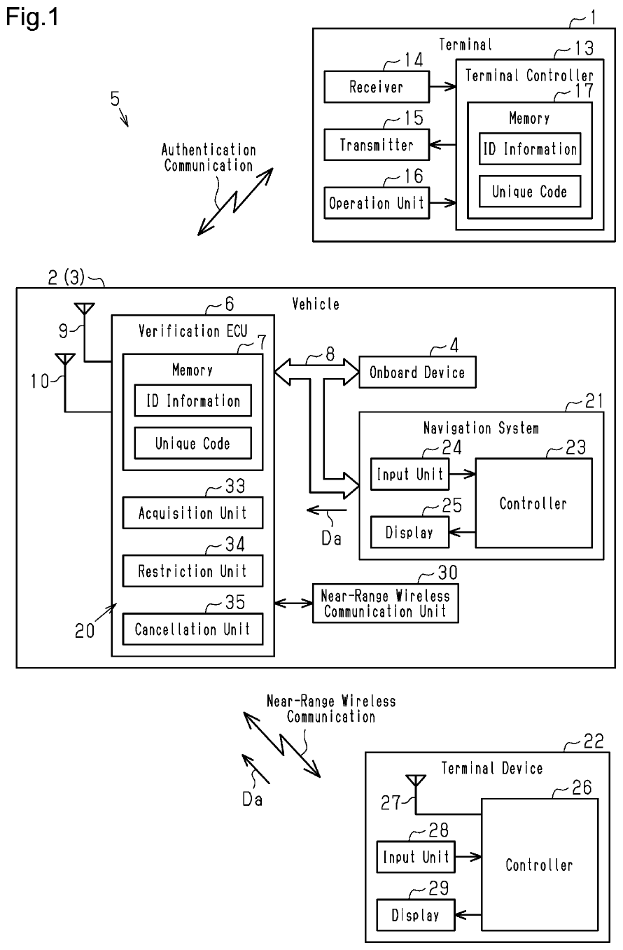

A communication control system and a communication control method according to one embodiment will now be described with reference to FIGS. 1 to 7.

As shown in FIG. 1, a vehicle 3, which is an operation subject 2 for a terminal 1, includes a key system 5 that performs ID verification through authentication communication with the terminal 1 to control the actuation of an onboard device 4. The key system 5 may also be referred to as a terminal authentication system that authenticates the terminal through authentication communication. Examples of the key system 5 include a smart verification system that performs ID verification through bidirectional communication when communication is initiated by the terminal 1, a wireless key system that performs ID verification when communication is initiated by the terminal 1, and the like. The terminal 1 is preferably an electronic key that substantially has, for example, key functionality. Examples of the onboard device 4 include a door locking device that performs locking and unlocking actions for a vehicle door, an engine device that controls an engine, and the like.

The vehicle 3 includes a verification ECU 6 that authenticates the terminal 1. The verification ECU 6 includes a memory 7 that stores ID information and a unique code of the terminal 1 registered to the vehicle 3. The verification ECU 6 is connected to the onboard device 4 by an interior communication line 8. Preferably, examples of the communication line 8 include a controller area network (CAN) and a local interconnect network (LIN).

The verification ECU 6 is connected to a radio wave transmitter 9 that is configured to transmit radio waves from the vehicle 3 during ID verification and a radio wave receiver 10 that is configured to receive radio waves at the vehicle 3 during ID verification. The radio wave transmitter 9 transmits radio waves in, for example, the low frequency (LF) band. The radio wave transmitter 9 preferably includes an exterior transmitter that transmits LF radio waves outside the passenger compartment of the vehicle 3 and an interior transmitter that transmits LF radio waves inside the passenger compartment of the vehicle 3. The radio wave receiver 10 receives radio waves in, for example, the ultra-high frequency (UHF) band.

The terminal 1 includes a terminal controller 13 that controls actions of the terminal 1, a receiver 14 that receives radio waves at the terminal 1 during ID verification, a transmitter 15 that transmits radio waves from the terminal 1 during ID verification, and an operation unit 16 that is operated to operate the vehicle 3 from a remote location. The terminal controller 13 includes a memory 17 that stores the unique ID information and the unique code stored in the terminal 1. The receiver 14 receives LF radio waves. The transmitter 15 transmits UHF radio waves. Examples of the operation unit 16 include a lock button, which is operated to lock the vehicle door through a remote operation, and an unlock button, which unlocks the vehicle door through a remote operation.

When the vehicle 3 is actuated in the smart verification system, the terminal 1 receives a wake signal, which is transmitted in LF from the radio wave transmitter 9 at regular or irregular intervals. The terminal 1, which is activated upon receipt of the wake signal with the receiver 14, transmits in UHF an acknowledgment signal from the transmitter 15 to the vehicle 3. When the radio wave receiver 10 receives the acknowledgment signal from the terminal 1, the verification ECU 6 recognizes that communication is established and performs smart verification as ID verification. Preferably, the smart verification includes ID information verification that checks the authenticity of ID information and challenge-response authentication that uses the unique code.

When determining that smart verification has been accomplished with the terminal 1 located outside the passenger compartment, in other words, when determining that exterior smart verification has been accomplished, the verification ECU 6 locks or unlocks the vehicle door or permits the locking and unlocking of the vehicle door. Thus, the vehicle door will be unlocked if the lock button of an exterior door handle is operated and the vehicle door is in a lock state, and the vehicle door will be locked if the exterior door handle is touched and the vehicle door is in an unlock state. When determining that smart verification has been accomplished with the terminal 1 located inside the passenger compartment, in other words, when determining that interior smart verification has been accomplished, the verification ECU 6 permits shifting of the state of a vehicle power supply. Thus, the engine can be started by, for example, operating an engine switch, which is located near the driver seat when the brake pedal is depressed.

The vehicle 3 includes a communication control system 20 that restricts the actuation of the vehicle 3, which is the operation subject 2, during a time period that is set by the user. The communication control system 20 of the present example restricts the actuation of the vehicle 3 in accordance with setting information Da input by a user. The communication control system 20 is included in the vehicle 3 to prevent an unauthorized operation of the vehicle 3 when, for example, the terminal 1 is located at a position remote from the vehicle 3 and connected to the vehicle 3 through communication established in an unauthorized manner by a relay or the like.

In the communication control system 20, an onboard navigation system 21 or a terminal device 22 carried by the user is used to input setting information Da. The navigation system 21 includes an input unit 24, a display 25, and a controller 23 that controls the operation of the system 21. The navigation system 21 is arranged on the center console or the like of the vehicle 3 and connected to the interior communication line 8. The input unit 24 may be, for example, a button shown on the display 25, which is of a touch panel type, or a mechanical switch. In the navigation system 21, the display screen of the display 25 is operated by the input unit 24.

The terminal device 22 is, for example, a high-performance mobile phone. The terminal device 22 includes a controller 26 that controls the operation of the terminal device 22, a near-range wireless communication unit 27 that performs near-range wireless communication, an input unit 28, and a display 29. The terminal device 22 is allowed to perform near-range wireless communication with the vehicle 3 when the near-range wireless communication unit 27 is connected to a near-range wireless communication unit 30 of the vehicle 3. The input unit 28 may be, for example, a button shown on the display 29, which is of a touch panel type, or a mechanical switch. In the terminal device 22, the display screen of the display 29 is operated by the input unit 28.

The communication control system 20 includes an acquisition unit 33 that obtains the setting information Da input by the user. The acquisition unit 33 is arranged in the verification ECU 6. If the vehicle 3 is actuated or allowed to be actuated through authentication communication performed with the terminal 1, the acquisition unit 33 obtains the setting information Da, which is related to a restriction on the actuation of the vehicle 3, when the user inputs the setting information Da. When the setting information Da is input with the navigation system 21, the acquisition unit 33 obtains the setting information Da through the communication line 8. When the setting information Da is input with the terminal device 22, the acquisition unit 33 obtains the setting information Da through near-range wireless communication.

The communication control system 20 includes a restriction unit 34 that restricts the actuation of the vehicle 3 when a condition based on the setting information Da is satisfied. The restriction unit 34 is arranged in the verification ECU 6. The restriction unit 34 of the present example restricts the actuation of the vehicle 3 during a time period that is specified in the setting information Da. The restriction on the actuation of the vehicle 3 includes, for example, a restriction on authentication communication, that is, a restriction on smart communication. The restriction on the actuation of the vehicle 3 also includes, for example, restriction on the shifting of the state of the vehicle power supply, that is, a restriction on the starting of the engine.

The communication control system 20 includes a cancellation unit 35 that cancels the restriction on the actuation of the vehicle 3. The cancellation unit 35 is arranged in the verification ECU 6. The cancellation unit 35 cancels a state in which the actuation of the vehicle 3 is restricted based on a cancellation operation performed by the user. Restriction cancellation may be performed by, for example, operating the operation unit 16 of the terminal 1 to remotely operate the vehicle 3, prompting the user to enter a passcode, or the like.

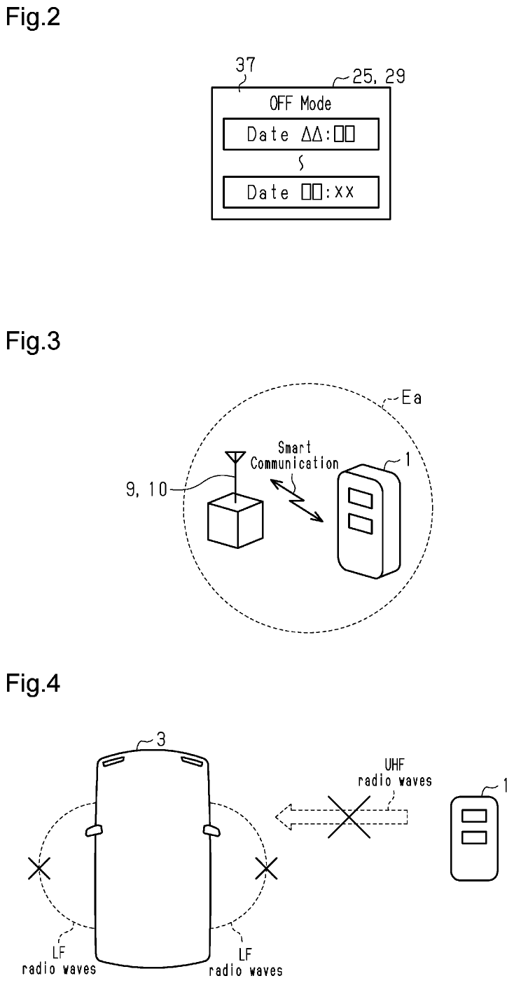

With reference to FIGS. 2 to 7, the operation of the communication control system 20 in the present embodiment will now be described.

As shown in FIG. 2, when the engine of the vehicle 3 is off, the user uses the navigation system 21 or the terminal device 22 to set a date and time during which the actuation of the vehicle 3 is restricted. In the present example, for example, the display 25 of the navigation system 21 or the display 29 of the terminal device 22 includes a setting screen 37 for inputting setting information Da. The setting screen 37 includes an input box used to input the setting information Da, which is data about the date and time during which the actuation of the vehicle 3 is to be restricted. Preferably, the setting information Da is data about the time period during which the actuation of the vehicle 3 is to be restricted. The restriction on the actuation of the vehicle 3 may be, for example, a restriction on communication performed by the key system 5 between the terminal 1 and the vehicle 3, a restriction on the shifting of the state of the vehicle power supply, and the like.

As shown in FIG. 3, after the setting information Da is input, when communication is established between the terminal 1 and the vehicle 3, the operation mode of the key system 5 shifts to an OFF mode. Smart verification does not necessarily have to be completed to establish communication. As long as the presence of the terminal 1 in the vicinity of the vehicle 3 can be acknowledged, communication is established when the terminal 1 receives LF radio waves from the vehicle 3 or when the vehicle 3 receives UHF radio waves from the terminal 1. In this manner, after the terminal 1 enters a communication area Ea of the vehicle 3, the key system 5 shifts to the OFF mode. The OFF mode sets the key system 5 to a restricted state, which, in turn, sets the vehicle 3 to the restricted state at the time set in the setting information Da, which is input by the user. Specifically, the vehicle 3 does not shift to the restricted state when the setting information Da is input. The vehicle 3 shifts to the restricted state at the time set in the setting information Da. Even when, for example, the terminal 1 moves out of the communication area Ea after the key system 5 shifts to the OFF mode, the OFF mode is maintained until the vehicle 3 shifts to the restricted state in accordance with the setting information Da. In one example, the OFF mode is maintained until the vehicle 3 shifts to the restricted state in accordance with the setting information Da and the OFF mode is maintained until the restricted state is canceled.

When the key system 5 is in the OFF mode, the acquisition unit 33 obtains the setting information Da of the OFF mode input by the user. In the present example, when the terminal 1 enters the communication area Ea of the radio wave transmitter 9 and smart communication is established, the acquisition unit 33 obtains the setting information Da from the navigation system 21 or the terminal device 22. When the setting information Da is input with the navigation system 21, the acquisition unit 33 obtains the setting information Da from the navigation system 21 through the communication line 8. When the setting information Da is input with the terminal device 22, the acquisition unit 33 obtains the setting information Da from the terminal device 22 through Bluetooth (registered trademark) near-range wireless communication.

As shown in FIG. 4, when the key system 5 is in the OFF mode, the restriction unit 34 sets the vehicle 3 to the restricted state at the date and time or time during which the actuation of the vehicle 3 is to be restricted. The restriction unit 34 monitors the present time using a timer or the like, which is installed in the vehicle 3, to restrict the actuation of the vehicle 3 at the set date and time. When the vehicle 3 shifts to the restricted state, the radio wave transmitter 9 does not transmit LF radio waves. When the vehicle 3 shifts to the restricted state, the terminal 1 does not transmit a reply in UHF radio waves even when receiving radio waves from the vehicle 3.

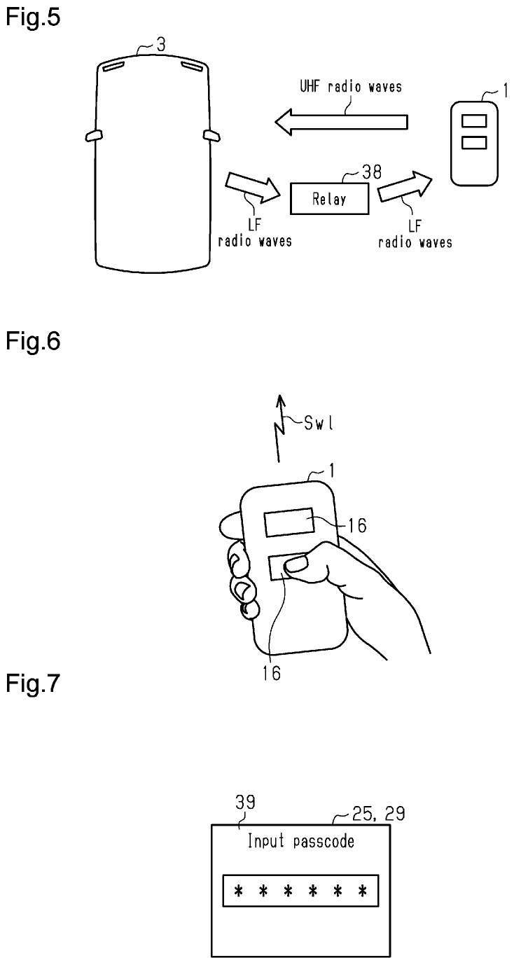

As shown in FIG. 5, a fraudulent act may be performed to establish smart communication in an unauthorized manner by using a relay 38 to relay the LF radio waves transmitted from the radio wave transmitter 9 of the vehicle 3 to the terminal 1 located distant from the vehicle 3. Such a fraudulent act may accomplish smart verification unintended by the user and result in unauthorized use of the vehicle 3.

In the present example, as long as the key system 5 is set in the OFF mode, from the date and time or time during which the actuation of the vehicle 3 is restricted, smart communication will be restricted. Thus, the radio wave transmitter 9 will not transmit radio waves and, hence, no reply will be transmitted from the terminal 1. In one example, when the terminal 1 enters the communication area Ea and establishes communication with the vehicle 3, the key system 5 is set in the OFF mode. When a condition included in the setting information Da is satisfied in the OFF mode, the actuation of the key system 5 is restricted. This, in turn, restricts the actuation of vehicle 3. Even when the user leaves the vehicle 3 and the terminal 1 moves out of the communication area Ea, the OFF mode is maintained until the actuation of the key system 5 is restricted in accordance with the setting information Da. When the actuation of the key system 5 is restricted, a fraudulent act using the relay 38 will not be able to actuate the key system 5. Thus, smart communication will not be accomplished in an unauthorized manner. This improves the security against unauthorized use of the vehicle 3.

As shown in FIG. 6, the restriction on smart communication, which is a restriction on the vehicle 3, is canceled on condition that, for example, the operation unit 16 of the terminal 1 is operated. In the present example, communication can be initiated by the terminal 1. Thus, when the operation unit 16 of the terminal 1 is operated, the terminal 1 transmits in UHF a wireless signal Sw1 including a command that is in accordance with the operation of the operation unit 16. The radio wave receiver 10 of the vehicle 3 receives the wireless signal Sw1 transmitted from the terminal 1. When the radio wave receiver 10 receives the wireless signal Sw1, the verification ECU 6 verifies the ID information in the wireless signal Sw1. When the verification is accomplished, the verification ECU 6 unlocks the vehicle door in accordance with a command in the wireless signal Sw1.

The cancellation unit 35 cancels the restriction on smart communication when receiving a valid wireless signal Sw1 from the terminal 1. The vehicle 3 returns to a state in which an operation performed through smart communication is allowed. Even when the restriction on the smart communication is canceled, the restriction on the starting of the engine is not canceled. Restriction cancellation is permitted in a stepped manner to improve security against car theft.

As shown in FIG. 7, the restriction on the shifting of the state of the vehicle power supply, which is a restriction on the key system 5 (vehicle 3), is canceled on condition that a valid passcode is input. In the present example, the user uses the navigation system 21 or the terminal device 22 to perform an operation for canceling the restriction. Preferably, the cancellation operation is performed by inputting, for example, a passcode to the navigation system 21 or the terminal device 22. The passcode may be preferred code information, which is set in advance by the user, or unique code information, which is otherwise set in advance.

When detecting a cancellation operation performed with the operation unit 16 of the terminal 1, the cancellation unit 35 displays a cancellation screen 39 on the display 25 or the display 29. The user inputs a passcode to the input box of the cancellation screen 39. The cancellation unit 35 verifies the passcode by comparing the input passcode with a passcode registered in advance and determines. When the passcodes are in correspondence, the cancellation unit 35 cancels the restriction on the shifting of the state of the vehicle power supply. This allows the user to start the engine by operating the engine switch located near the driver seat.

The communication control system 20 of the above embodiment has the advantages described below.

When the vehicle 3 is actuated or allowed to be actuated through authentication communication with the terminal 1 and setting information Da related to a restriction on the actuation of the vehicle 3 is input by the user, the acquisition unit 33 of the communication control system 20 obtains the setting information Da. The restriction unit 34 of the communication control system 20 restricts the actuation of the vehicle 3 when a condition in the setting information Da is satisfied. Thus, when the setting information Da related to a restriction on the actuation of the vehicle 3 is input, the actuation of the vehicle 3 is restricted at the time period specified in the setting information Da. Thus, operation of the vehicle 3 can be restricted at a time during which unauthorized operation of the vehicle 3 may occur. This improves security against unauthorized use of the vehicle 3.

After the setting information Da is input, when communication is established between the terminal 1 and the vehicle 3, the restriction unit 34 switches the operation mode of the key system 5, which performs authentication communication, to the OFF mode that restricts the actuation of the vehicle 3. In the OFF mode, the restriction unit 34 shifts the operation mode to a state that restricts the actuation of the vehicle 3 when a condition in the setting information Da is satisfied. Thus, as long as the key system 5 is switched to the OFF mode in advance, the actuation of the vehicle 3 is automatically restricted at the time period specified in the setting information Da.

Authentication communication includes smart communication for authenticating the terminal 1 through bidirectional communication when the authentication communication (i.e., smart communication) is initiated by the vehicle 3. Restriction on the actuation of the vehicle 3 is at least one of a restriction situation in which the vehicle 3 does not transmit radio waves toward the terminal 1 and a restriction situation in which, even if the terminal 1 receives radio waves from the vehicle 3, the terminal 1 does not transmit a reply in response to the radio waves. Thus, the restriction provides double security and further improves security against unauthorized use of the vehicle 3.

When the actuation of the vehicle 3 is restricted, the cancellation unit 35 of the communication control system 20 cancels the restriction when the user performs a cancellation operation. Thus, even when the actuation of the vehicle 3 is restricted, the restriction can be canceled to return the vehicle 3 to the original state.

The present embodiment may be modified as follows. The present embodiment and the following modifications can be combined as long as the combined modifications remain technically consistent with each other.

Setting Information Da and Acquisition Unit 33

The setting information Da is not limited to the information about the date and time or time for restricting operation of the vehicle 3 and the key system 5. For example, the setting information Da may be information for restricting the actuation of the vehicle 3 and the key system 5 when a predetermined impact is applied to the vehicle 3 or when the vehicle 3 is not used over a certain time or longer.

The setting information Da may be input with different types of conditions (time, time period, impact detection, and other conditions) for restricting the actuation of an operation subject.

The setting information Da does not need to be input with the navigation system 21 or the terminal device 22. Instead, the setting information Da may be input with, for example, the terminal 1 or a desktop personal computer.

The vehicle 3 does not necessarily have to shift to a restricted state after the setting information Da is input when the key system 5 shifts to the OFF mode and a restriction condition is satisfied in the OFF mode. For example, after the setting information Da is input, if the restriction condition is not satisfied, the key system 5 may remain in a normal operation mode and the vehicle 3 may shift to a restricted state when the restriction condition is satisfied. That is, the OFF mode may be a state in which a restriction is imposed on the key system 5 (vehicle 3).

The acquisition unit 33 does not need to be arranged in the verification ECU 6. Instead, the acquisition unit 33 may be arranged in another ECU or device.

The acquisition unit 33 may obtain the setting information Da input by the user through the Internet.

Condition in the Setting Information Da

A condition in the setting information Da may be a numerical value in the input setting information Da or a value such as a criterion for determination that is obtained from the setting information Da.

A condition in the setting information Da does not need to be a single condition and may be multiple conditions.

Restriction and Restriction Unit 34

Restriction does not necessarily refer to disabling smart communication or disabling engine starting. Various restrictions can be imposed. For example, the number of times the engine of the vehicle 3 starts may be restricted, the maximum speed of the vehicle 3 may be restricted, or the traveling area of the vehicle 3 may be restricted.

The restriction unit 34 does not need to be arranged in the verification ECU 6. Instead, the restriction unit 34 may be arranged in another ECU or device.

Cancellation of Restriction and Cancellation Unit 35

The restriction may be canceled with an immobilizer system on condition that the terminal 1 is held near an antenna of the vehicle body and authentication is accomplished in near-range wireless communication. Restriction may also be canceled on condition that the operation unit 16 of the terminal 1 is operated after the vehicle door is opened or closed.

The restriction may be canceled on condition that, for example, a component of the vehicle body is operated a predetermined number of times through a predetermined procedure. For example, the restriction may be canceled when an exterior door handle is operated a predetermined number of times through a predetermined procedure.

The restriction does not need to be canceled in steps and may be fully canceled through a single cancellation operation. In one example, when a passcode is input in the restricted state, the restriction on the vehicle 3 may be fully canceled.

The cancellation unit 35 does not need to be arranged in the verification ECU 6. Instead, the cancellation unit 35 may be arranged in another ECU or device.

Authentication Communication

The authentication communication is not limited to smart communication. Authentication communication only needs to be performed to authenticate the terminal 1.

Authentication communication is not limited to bidirectional communication between the terminal 1 and the vehicle 3 and may be unidirectional communication.

Authentication communication is not limited to communication for verifying the authenticity of ID information registered to the terminal 1 and may include communication for verifying the authenticity of other parameters.

Key System 5

In the key system 5, the radio wave transmitter 9 does not need to include the exterior transmitter and the interior transmitter. Instead, the radio wave transmitter 9 may cover the outside and the inside of the passenger compartment.

The key system 5 is not limited to a smart verification system or a wireless key system. Instead, the key system 5 may be an immobilizer system or an authentication system using near-range wireless communication.

The key system 5 only needs to be a system that verifies the authenticity of the terminal 1 through wireless communication.

Others

The terminal device 22 is not limited to a high-performance mobile phone and may be another terminal such as an electronic key that substantially has, for example, key functionality. In other words, the terminal 1 may have the functionality of the terminal device 22.

The operation subject 2 is not limited to the vehicle 3. The operation subject 2 only needs to be a machine or device that is operated through communication with the terminal 1.

Any one or more of devices that form the communication control system 20 of the present disclosure (such as verification ECU 6, radio wave transmitter 9, radio wave receiver 10, near-range wireless communication unit 30, navigation system 21, terminal 1, and/or terminal device 22) can be configured to be a computer system including one or more processors and a non-transitory memory that stores instructions executable by the processor to implement various types of processes (including authentication communication and/or communication control process in present disclosure) in accordance with the above embodiment or the above modification. The communication control process in the present disclosure includes, as described above, the process for shifting the key system 5 to the OFF mode, the process for shifting the key system 5 (vehicle 3) to the restricted state after the shift to the OFF mode, and/or the process for returning the key system 5 (vehicle 3) from the restricted state to the restriction canceled state or returning in steps. Alternatively, any one or more of the devices included in the communication control system 20 may be configured with dedicated hardware such as an application-specific integrated circuit (ASIC).

The present disclosure includes the following embodiments.

### Embodiment 1

A computer system including:

one or more processors; and

a non-transitory memory that stores instructions executable by the one or more processors to implement communication control process,

where the communication control process includes
obtaining setting information (Da) including a condition for restricting actuation of an operation subject (2) operated by a terminal (1) through authentication communication with the terminal (1), and
restricting the actuation of the operation subject when the condition in the setting information is satisfied.

### Embodiment 2

The computer system according to embodiment 1, where

the terminal (1) and the operation subject (2) form a terminal authentication system (5) that authenticates the terminal through the authentication communication, and

the communication control process further includes

shifting the authentication system (5) to an OFF mode after the terminal (1) enters a communication area (Ea) for communicating with the operation subject (2), and

restricting actuation of the operation subject (2) in the OFF mode when the condition in the setting information (Da) is satisfied.

### Embodiment 3

The computer system according to embodiment 1 or 2, where the communication control process further includes canceling restriction on the actuation of the operation subject (2) when a user performs a cancellation operation with the terminal (1).

### Embodiment 4

The computer system according to any one of embodiments 1 to 3, where

the one or more processors and the non-transitory memory are installed in the operation subject (2) and implemented as a verification ECU (6) that verifies the terminal (1), and

the verification ECU (6) obtains the setting information (Da) from at least one of the terminal (1), a system (21) installed in the operation subject (2) and configured to communicate with the verification ECU (6), and a device (22) that is separate from the terminal (1) and configured to communicate with the verification ECU (6).

1. A communication control system comprising:
an acquisition unit that obtains setting information when the setting information is input by a user, wherein the setting information is related to a restriction on actuation of an operation subject that is actuated or allowed to be actuated through authentication communication performed with a terminal; and
a restriction unit that restricts actuation of the operation subject when a condition in the setting information is satisfied.

2. The communication control system according to claim 1, wherein, after the setting information is input, when communication is established between the terminal and the operation subject, the restriction unit switches an operation mode of a key system, which performs the authentication communication, to an OFF mode that allows actuation of the operation subject to be restricted, and the restriction unit restricts actuation of the operation subject when the condition in the setting information is satisfied in the OFF mode.

3. The communication control system according to claim 1, wherein
the authentication communication includes communication for authenticating the terminal through bidirectional communication when the authentication communication is initiated by the operation subject, and
the restriction on actuation of the operation subject is at least one of a restriction situation in which the operation subject does not transmit radio waves toward the terminal and a restriction situation in which, even if the terminal receives radio waves from the operation subject, the terminal does not transmit a reply in response to the radio waves.

4. The communication control system according to claim 1, further comprising:
a cancellation unit that cancels a restriction on actuation of the operation subject when the user performs a cancellation operation in a state in which the actuation of the operation subject is restricted.

5. A communication control method, comprising:
obtaining setting information with an acquisition unit when the setting information is input by a user, wherein the setting information is related to a restriction on actuation of an operation subject that is actuated or allowed to be actuated through authentication communication performed with a terminal; and
restricting actuation of the operation subject with a restriction unit when a condition in the setting information is satisfied.
